(19) United States
(12) Patent Application Publication
(10) Pub. No.: US 2005/0027717 A1
(43) Pub. Date: Feb. 3, 2005

(54) Text joins for data cleansing and integration in a relational database management system

(76) Inventors: Nikolaos Koudas, New York, NY (US); Divesh Srivastava, Summit, NJ (US); Luis Gravano, New York, NY (US); Panagiotis G. Ipeirotis, New York, NY (US)

Correspondence Address: Salvatore J. Abburzzese;HOFFMAN & BARON, LLP, 6900 Jericho Turnpike, Syosset, NY, 11791, US

(21) Appl. No.: 10/828,819

(22) Filed: Apr. 21, 2004

Related U.S. Application Data
(60) Provisional application No. 60/464,101, filed on Apr. 21, 2003.

(51) Int. Cl. G06F 17/30

(52) U.S. Cl. 707/100

(57) ABSTRACT

An organization's data records are often noisy: because of transcription errors, incomplete information, and lack of standard formats for textual data. A fundamental task during data cleansing and integration is matching strings—perhaps across multiple relations—that refer to the same entity (e.g., organization name or address). Furthermore, it is desirable to perform this matching within an RDBMS, which is where the data is likely to reside. In this paper, We adapt the widely used and established cosine similarity metric from the information retrieval field to the relational database context in order to identify potential string matches across relations. We then use this similarity metric to characterize this key aspect of data cleansing and integration as a join between relations on textual attributes, where the similarity of matches exceeds a specified threshold. Computing an exact answer to the text join can be expensive. For query processing efficiency, we propose an approximate, sampling-based approach to the join problem that can be easily and efficiently executed in a standard, unmodified RDBMS. Therefore the present invention includes a system for string matching across multiple relations in a relational database management system comprising generating a set of strings from a set of characters, decomposing each string into a subset of tokens, establishing at least two relations within the strings, establishing a similarity threshold for the relations, sampling the at least two relations, correlating the relations for the similarity threshold and returning all of the tokens which meet the criteria of the similarity threshold.

### CROSS-REFERENCE TO RELATED APPLICATIONS

This application claims priority of U.S. Provisional Application No. 60/464,101, filed on, Apr. 21, 2003, which is incorporated by reference herein.

### BACKGROUND OF THE INVENTION

1. Field of the Invention

This invention relates to a method for identifying potential string matches across relations within a relational database management system.

2. Description of Related Art

Integrating information from a variety of homogeneous or heterogeneous data sources is a problem of central interest. With the prevalence of the web, a number of emerging applications, such as catalog integration and warehousing of web data (e.g., job advertisements and announcements), face data integration at the very core of their operation. Corporations increasingly request to obtain unified views of their information (e.g., customers, employees, products, orders, suppliers), which makes data integration of critical importance. Data integration also arises as a result of consolidation (e.g., mergers and takeovers) both at inter- as well as intra-corporation levels. Consider a large service provider corporation offering a variety of services. The corporation records a multitude of information per customer (such as name and address) in corporate databases. This information often excludes unique global identifiers (such as Social Security Number) in accordance with corporate or federal policies. Customers subscribe to one or more services. Due to a variety of reasons—including the specifics of the business model and organization boundaries different information systems with customer information may be maintained for each service. Let R1 and R2 be two relations recording the name and address of customers of two services. In the presence of global identifiers, a straightforward join between R₁ and R₂ on the unique identifier would match customers across both services. In the absence of global identifiers, deducing whether two or more customers represent the same entity turns out to be a challenging problem, since one has to cope with mismatches arising from:
erroneous information (for example, typing mistakes when customer information is acquired),
missing or incomplete information,
differences in information “formatting” due to the lack of standard conventions (e.g., for addresses)
or a combinations of any of the preceding errors.

For example, observing the name attribute instances “AT&T Research” of relation R₁, and “ATT Research Labs” (or “AT&T Labs Research”) of R₂, can we deduce that they correspond to the same entity. Are “AT&T Research” and “AT&T Research Labs” more likely to correspond to the same entity than “AT&T Research” and “AT&T Labs Research”? If we consider the additional address field, are the instances (“AT&T Research”, “Florham Park”), (“AT&T Research Labs”, “Florham Park NJ”) more likely to correspond to the same entity than (“AT&T Research”, “Florham Park”), (“AT&T Labs Research”,“Menlo Park CA”)? Any attempt to address the integration problem has to specify a measure that effectively quantifies “closeness” or “similarity” between string attributes. Once this measure is specified, there is a clear need for algorithms that efficiently process the data sources and join them to identify all pairs of strings (or sets of strings) that are sufficiently similar to each other. Furthermore, it is desirable to perform such a join, which we refer to as a text-join, within an unmodified relational database management system (RDBMS),which is where the data is likely to reside The present invention defines text-joins using the cosine similarity metric to quantify string similarity, as well as defines algorithms to process text joins efficiently in an RDBMS.

### SUMMARY OF THE INVENTION

The present invention provides a system for string matching across multiple relations in a relational database management system comprising generating a set of strings from a set of characters, decomposing each string into a subset of tokens, establishing at least two relations within the strings, establishing a similarity threshold for the relations, sampling the at least two relations, correlating the relations for the similarity threshold and returning all of the tokens which meet the criteria of the similarity threshold.

### BRIEF DESCRIPTION OF THE DRAWINGS

The various features, objects, benefits, and advantages of the present invention will become more apparent upon reading the following detailed description of the preferred embodiment(s) along with the appended claims in conjunction with the drawings, wherein like reference numerals identify like components throughout, and:

FIG. 1 depicts an example of an SQL statement according to the present invention.

FIG. 2 depicts an example of the algorithm according to the present invention for computing the exact value of a particular relation.

FIG. 3 depicts an example of the algorithm according to the present invention for computing a sample relation.

FIG. 4 depicts an alternate example of the algorithm according to the present invention for computing a sample relation.

FIG. 5 depicts an example of the SQL algorithm according to the present invention for computing the weight and thresholding steps.

FIG. 6 depicts an example of the algorithm according to the present invention for a symmetric sampling-based text join.

FIG. 7 depicts an alternate example of the algorithm according to the present invention for a symmetric sampling-based text join.

FIGS. 8a and 8b are graphs of two data sets for relations according to the present invention.

FIGS. 9a, 9b and 9c depict graphs of the average precision and recall of different algorithms according to the present invention.

FIGS. 10a, 10b and 10c depict graphs of the average precision and recall of different algorithms according to the present invention.

FIGS. 11a and 11b depict graphs of the average precision and recall of different algorithms according to the present invention.

FIGS. 12a, 12b, 12c and 12d depict graphs of the average execution times of different algorithms according to the present invention.

### DETAILED DESCRIPTION OF THE INVENTION

In describing this invention there is first provided a notation and background for text joins, which we follow with a formal definition of the problem on which we focus in this paper. We denote with Σ* the set of all strings over an alphabet . Σ Each string in Σ* can be decomposed into a collection of atomic “entities” that we generally refer to as tokens. What constitutes a token can be defined in a variety of ways. For example, the tokens of a string could simply be defined as the “words” delimited by special characters that are treated as “separators” (e.g.,“ ”) alternatively, the tokens of a string could correspond to all of its q-grams, which are overlapping substrings of exactly q consecutive characters, for a given q. In the following discussion, the term token is treated as generic, as the particular choice of token is orthogonal to the design of our algorithms.

Let R₁ and R₂ be two relations with the same or different schemas and attributes. To simplify our discussion and notation we assume, without loss of generality, that we assess similarity between the entire sets of attributes of R₁ and R₂. Our discussion extends to the case of arbitrary subsets of attributes in a straightforward way. Given tuples:
tᵢ∈R₁ and t₂∈R₂,
we assume that the values of their attributes are drawn from Σ*. We adopt the vector-space retrieval model to define the textual similarity between t₁ and t₂.

Let D be the (arbitrarily ordered) set of all unique tokens present in all values of attributes of both R₁ and R₂. According to the vector-space retrieval model, we conceptually map each tuple
t∈Rᵢ
to a vector
νₜ∈R^{|D|}

The value of the j-th component νₜ(j) of νₜ is a real number that corresponds to the weight of the j-th token of D in νₜ. Drawing an analogy with information retrieval terminology, D is the set of all terms and νₜ is a document weight vector.

Rather than developing new ways to define the weight vector v, for a tuple
t∈Rᵢ,
we exploit an instance of the well-established tf.idf weighting scheme from the information retrieval field. (tf.idf stands for “term frequency, inverse document frequency.”) Our choice is further supported by the fact that a variant of this general weighting scheme has been successfully used for our task by Cohen's WHIRL system. Given a collection of documents C, a simple version of the tf.idf eight for a term w and a document d is defined as;
tf_{w} log(idf_{w}),
where
tf_{w} is the number of times that w appears in document d and
idf_{w},
is

$$\frac{\vert C \vert}{{n}_{w}} ,$$

where n_{w} is the number of documents in the collection C that contain term w. The tf.idf weight for a term w in a document is high if w appears a large number of times in the document and w is a sufficiently “rare” term in the collection (i.e., if w's discriminatory power in the collection is potentially high). For example, for a collection of company names, relatively infrequent terms such as “AT&T” or “IBM” will have higher idf weights than more frequent terms such as “Inc.”

For our problem, the relation tuples are our “documents,” and the tokens in the textual attribute of the tuples are our “terms.” Consider the j-th token w in D and a tuple t from relation Rᵢ. Then tfw is the number of times that w appears in t. Also, idfw is:

$$\frac{\vert {R}_{i} \vert}{{n}_{w}} ,$$

where n_{w} is the total number of tuples in relation Rᵢ that contain token w. The if.idf weight for token w in tuple;
t∈Rᵢ is νₜ(j)=tf_{w} log(idf_{w})

To simplify the computation of vector similarities, we normalize vector νₜ to unit length in the Euclidean space after we define it (the resulting weights corresponds to the impact of the terms).

Note that the weight vectors will tend to be extremely sparse for certain choices of tokens; we shall seek to utilize this sparseness in our proposed techniques

Definition 1 (Cosine Similarity) Given tuples t₁∈R₁ and t₂∈R₂, let νₜ_{₁} and νₜ_{₂} be their corresponding normalized weight vectors and D is the set of all tokens in R₁ and R₂. The cosine similarity (or just similarity, for brevity) of νₜ_{₁} and νₜ_{₂} is defined as:

$$sim ( {v}_{{t}_{1}} , {v}_{{t}_{2}} ) = {\sum }_{j = 1}^{\vert D \vert} {v}_{{t}_{1}} ( j ) {v}_{{t}_{2}} ( j )$$

Since vectors are normalize his measure corresponds to the cosine of the angle between vectors νᵢ₁ and νᵢ₂, and has values between 0 and 1. The intuition behind this scheme is that the magnitude of a component of a vector expresses the relative “importance” of the corresponding token in the tuple represented by the vector. Intuitively, two vectors are similar if they share many important tokens. For example, the string “ACME” will be highly similar to “ACME Inc,” since the two strings differ only on the token “Inc,” which appears in many different tuples, and hence has low weight. On the other hand, the strings “IBM Research” and “AT&T Research” will have lower similarity as they share only one relatively common term. The following join between relations R₁ and R₂ brings together the tuples from these relations that are “sufficiently close” to each other according to a user-specified similarity threshold;
φ;

Definition 2 (Text-Join) Given two relations R₁ and R₂, together with a similarity threshold 0≦φ≦1, the text-join R₁ [symbol] _{φ}R₂ returns all pairs of tuples (t₁, t₂) such that:
t₁∈R₁ and t₂∈R₂, and
sim(νₜ_{₁}; νₜ_{₂})≧φ.

This text-join “correlates” two relations for a given similarity threshold
φ;

It can be easily modified to correlate arbitrary subsets of attributes of the relations. In this paper, we address the problem of computing the text-join of two relations efficiently and within an unmodified RDBMS: Problem 1 Given two relations R₁ and R₂, together with a similarity threshold 0≦φ≦1, we want to efficiently compute (an approximation of) the text-join
R₁ [symbol] _{φ}R₂
using “vanilla” SQL in an unmodified RDBMS. We first describe our methodology for deriving, in a preprocessing step, the vectors corresponding to each tuple of relations R₁ and R₂ using relational operations and representations. We then present our sampling-based solution for efficiently computing the text join of the two relations using standard SQL in an RDBMS

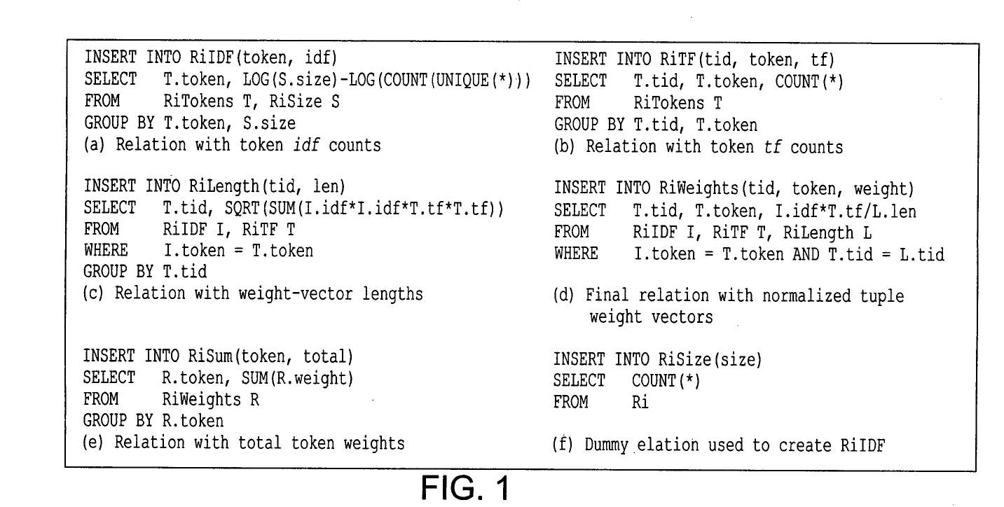

Creating Weight Vectors for Tuples In this section, we describe how we define auxiliary relations to represent tuple weight vectors. In the following section, we develop a sampling-based technique to compute the text-join of two relations starting with the auxiliary relations that we define next. As in the previous section, it is assumed that we want to compute the text-join
R₁ [symbol] _{φ}R₂
of two relations R₁ and R₂. D is the ordered set of all the tokens that appear in R₁ and R₂. We use SQL expressions to create the weight vector associated with each tuple in the two relations. Since for some choice of tokens each tuple is expected to contain only a few of the tokens in D, the associated weight vector is sparse. We exploit this sparseness and represent the weight vectors by storing only the tokens with non-zero weight. Specifically, for a choice of tokens (e.g., words or q-grams), we create the following relations for a relation R₁:
RiTokens(tid, token): Each tuple (tid, w) is associated with all occurrence of token w in the Rᵢ tuple with id tid. This relation is populated by inserting exactly one tuple (tid, w) for each occurrence of token w in a tuple of Rᵢ with tuple id tid. This relation can be implemented in pure SQL and the implementation varies with the choice of tokens. (See [?] for an example on how to create this relation when q-grams are used as tokens.)
Ri1DF(token, idf): A tuple (w, idf_{w}) indicates that token w has inverse document frequency idf_{w} (Section 2) in relation Rᵢ. The SQL statement to populate relation Ri1DF is Shown in FIG. 1(a). This statement relies on a “dummy” relation RiSize(size) (FIG. 1(f)) that has just one tuple indicating the number of tuples in Rᵢ.
RiTF(tid, token, tf): A tuple (tid, w, tf_{w}) indicates that token w has term frequency tf_{w} (Section 2) for Rᵢ tuple with tuple id tid. The SQL statement to populate relation RiTF'is shown in FIG. 1(b).
RiLength(tid, len): A tuple (tid, l) indicates that the weight vector associated with Rᵢ tuple with tuple id tid has a Euclidean norm of 1. (This relation is used for normalizing weight vectors.) The SQL statement to populate relation RiLength is shown in FIG. 1(c).
RiWeights(tid, token, weight): A tuple (tid, w, n) indicates that token w has normalized weight rt in Rᵢ tuple with tuple id tid. The SQL statement to populate relation RiWeights is shown in FIG. 1(d). This relation materializes a compact representation of the final weight vector for the tuples in Rᵢ.
RiSum(token, total): A tuple (w, t) indicates that token w has a total added weight t in relation Rᵢ, as indicated in relation RiWeights. These numbers are used during sampling (see Section 4). The SQL statement to populate relation RiSum is shown in FIG. 1(e).

Given two relations R₁ and R₂, we can use the SQL statements in FIG. 1 to generate relations R1Weights and R2Weights with a compact representation of the weight vector for the R₁ and R₂ tuples. Only the non-zero tf.idf weights are stored in these tables. The space overhead introduced by these tables is moderate. Since the size of RiSum is bounded by the size of RiWeights, we just analyze the space requirements for RiWeights. Consider the case where q-grams are the tokens of choice. (As we will see, a good value is q=3.) Then each tuple Rᵢ.tⱼ of relation Rᵢ can contribute up to approximately;
|Rᵢ.tⱼ|
q-grams to relation RiWeights, where
|Rᵢ.tⱼ|
is the number of characters in Rᵢ.tⱼ. Furthermore, each tuple in RiWeights consists of a tuple id tid, the actual token (i.e., q-gram in this case), and its associated weight. Then, if C bytes are needed to represent tid and weight, the total size of relation RiWeights will not exceed;

$${\sum }_{j = 1}^{\vert {R}_{i} \vert} ( C + q ) \cdot \vert {R}_{i} . {t}_{j} \vert = ( C + q ) \cdot {\sum }_{j = 1}^{\vert {R}_{i} \vert} \vert {R}_{i} . {t}_{j} \vert ,$$

which is a (small) constant times the size of the original table Ri. If words are used as the token of choice, then we have at most

$$\frac{\vert {R}_{i} . {t}_{j} \vert}{2}$$

tokens per tuple in Ri. Also, to store the token attribute of RiWeights we need no more than one byte for each character in the Rᵢ.tⱼ tuples. Therefore, we can bound the size of RiWeights by

$$1 + \frac{C}{2}$$

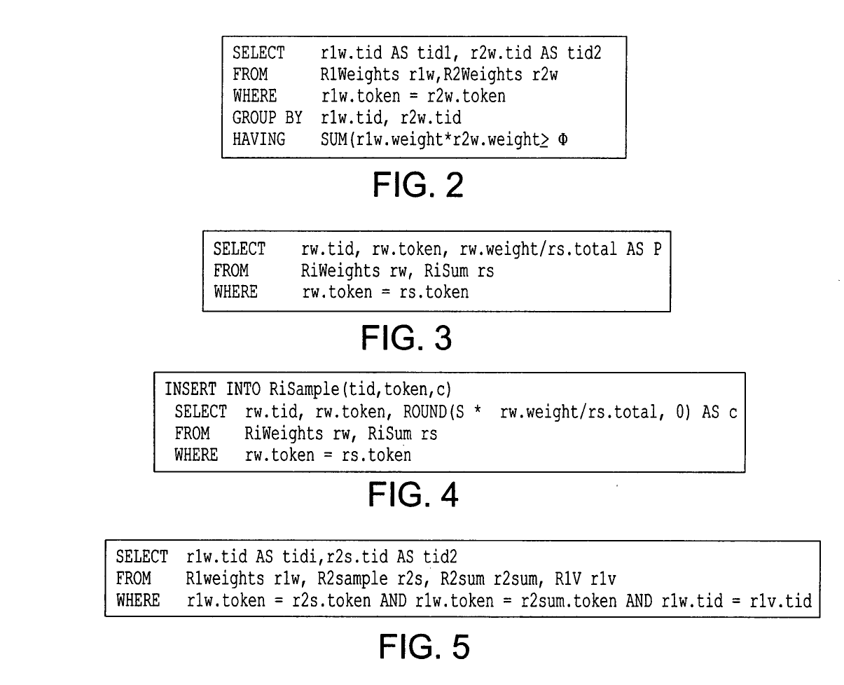

times the size of Ri. Again, in this case the space overhead is linear in the size of the original relation R. Given the relations R1Weights and R2Weights, a baseline approach to compute:
R₁ [symbol] _{φ}R₂
is shown in FIG. 2.

This SQL statement performs the text-join by computing the similarity of each pair of tuples and filtering out any pair with similarity less than the similarity threshold φ. This approach produces an exact answer to;
R₁ [symbol] _{φ}R₂ for φ>0,

As will be described later, finding an exact answer with this approach is expensive, which motivates the sampling-based technique that we describe next.

The result of R₁ [symbol] _{φ}R₂ only contains pairs of tuples from R₁ and R₂ with similarity φ or higher. Usually we are interested in high values for threshold φ, which should result in only a few tuples from R₂ typically matching each tuple from R₁. The baseline approach in FIG. 2, however, calculates the similarity of all pairs of tuples from R₁ and R₂ that share at least one token. As a result, this baseline approach is inefficient: most of the candidate tuple pairs that it considers do not make it to the final result of the text-join. In this section, we present a sampling-based technique to execute text-joins efficiently, drastically reducing the number of candidate tuple pairs that are considered during query processing. Our sampling-based technique relies on the following intuition:
R₁ [symbol] _{φ}R₂
could be computed efficiently if, for each tuple t_{q} of R₁, we managed to extract a sample from R₂ containing mostly tuples suspected to be highly similar to t_{q}. By ignoring the remaining (useless) tuples in R₂, we could approximate
R₁ [symbol] _{φ}R₂
efficiently. The key challenge then is how to define a sampling strategy that leads to efficient text-join executions while producing an accurate approximation of the exact query results. The discussion of our technique is organized as follows:
Similarity Sampling shows how to sample from R2, (unrealistically, but deliberately) assuming knowledge of all tuple-pair similarity values.
Token Weighted Sampling shows how to estimate the tuple-pair similarity values by sampling directly from the tuple vectors of R₂.
Finally, Practical Realization of Sampling describes an efficient algorithm for computing an approximation of the text-join.
   Similarity Sampling

The description of our approach will rely on the following conceptual vector, which will never be fully materialized and which contains the similarity of a tuple tq from relation R₁ with each tuple of relation R₂:
V(t_{q})=[sim(νₜ_{ᵥ}, νₜ_{₁}), . . . , sim(νₜ_{_{q}}, νₜ_{ᵢ}), . . . , sim(νₜ_{_{q}}, νₜ_{_{|R2|}})]

When t_{q} is clear from the context, to simplify the notation we use; σᵢ, as shorthand for
sim(νₜ_{_{q}}, νₜ_{ᵢ}).

Hence we have:
V(t_{q})=[σ₁, . . . , σᵢ, . . . , σ_{|R}_{₂}_{|}]

Intuitively, our techniques will efficiently compute an approximation of vector V(t_{q}) for each tuple;
t_{q}∈R₁.

The approximation can then be used to produce a close estimate of;
R₁ [symbol] _{φ}R₂.

Assume that V(t_{q}) is already computed and available at hand (we will relax this requirement in the next section). We define;
T_{V}(t_{q}) as the sum of all entries in;
V(t_{q}) (i.e. , Tv(t_{g}) is the sum of the similarity of tuple t_{q} with each tuple
tᵢ∈R₃:

$${T}_{V} ( {t}_{q} ) = {\sum }_{i = 1}^{\vert {R}_{2} \vert} {σ}_{i}$$

Now, consider taking a sample of some size S from the set of R₂ tuples;
{t₁, . . . , t_{|R}_{|}},
where the probability of picking;

$${p}_{i} = \frac{{σ}_{i}}{{T}_{V} ( {t}_{q} )}$$

(i.e., the probability of picking tᵢ is proportional to the similarity of R₂ tuple tᵢ and our “fixed” R₁ tuple t_{q}). To get the S samples, we consider each tuple tᵢ S times. Let Cᵢ be the number of times that tᵢ appears in the sample under this sampling strategy. We will show that;

$$\frac{{C}_{i}}{S} {T}_{V} ( {t}_{q} )$$

provides an estimate of σᵢ and we will establish a relationship between the sampling size S and the quality of estimation of σᵢ. Specifically, the probability that ti is included X times in a sample of size S is;

$$P [ {C}_{i} = τ ] = ( \begin{matrix}S \\ τ\end{matrix} ) {{p}_{i}^{τ} ( 1 - {p}_{i} )}^{( S - τ )}$$

In other words, each Cᵢ is a Bernoulli trial with parameter pi and mean S·pᵢ Moreover, the Cᵢ's are independent. According to the Hoeffding bounds, for n trials of binomial variable X with mean μ and for 0<e<1, we know:
P[X−μ>∈n]≦e^{-2nε}^{²} and
P[X−μ<−∈n]≦e^{-2nε}^{²}

Substituting in the equations above;

$$\begin{matrix}X = {C}_{i \vert} n = S , and μ = S \cdot {p}_{i} , where {p}_{i} = \frac{{σ}_{i}}{{T}_{V} ( {t}_{q} )} \text{:} & \\ P [ \frac{{C}_{i}}{S} {T}_{V} ( {t}_{q} ) - {σ}_{i} > ε {T}_{V} ( {t}_{q} ) ] \leq {ⅇ}^{- 2 {S}_{ε}^{2}} & ( 1 ) \\ and & \\ P [ \frac{{C}_{i}}{S} {T}_{V} ( {t}_{q} ) - {σ}_{i} < - ε {T}_{V} ( {t}_{q} ) ] \leq {ⅇ}^{- 2 {S}_{ε}^{2}} & ( 2 )\end{matrix}$$

Thus, we can get arbitrarily close to each σᵢ by choosing an appropriate sample size S.

Specifically, if we require the similarity estimation error;
εT_{V}(t_{q}) to be smaller than δₛ, and the probability of error;
e^{-3Se}^{²} be smaller than δₚ₁, we can solve the two inequalities;
eT_{V}(t_{q})≦δₛ and,
e^{2S}^{_{ε}}^{²}≦δₚ₁ to get a suitable sample size S:

$$S \geq \frac{ln ( {δ}_{p}^{- 1} )}{2 {δ}_{s}^{2}} {{T}_{V} ( {t}_{q} )}^{2}$$

The Sampling scheme that we described so far in this section is of course not useful in practice:

If we knew V(t_{q}), then we could just report all R₂ tuples with similarity;
σᵢ≧φ

In this section, it is described how to estimate the entries of V(t_{q}, by sampling directly from the set of tokens of R₂. As discussed, the sampling strategy outlined above cannot be immediately realized for our problem, since V(t_{q}) is not known a-priori. We now show how to perform sampling according to the values of V(t_{q}) without computing V(t_{q}) explicitly. Consider tuple

t_{q}∈R₁ with its associated token weight vector;

νₜ_{ᵢ}. We extract a sample of R₂ tuples of size S for tq—with no knowledge of V(t_{q}) as follows:

Identify each token j in t_{q} that has non-zero weight
   νₜ_{_{q}}(j), 1≦j≦|D|.

For each such token j, perform S Bernoulli trials over each;
tᵢ∈{t₁, . . . , t_{|R}_{₂}_{|})
where the probability of picking tᵢ in a trial depends on the weight of token j in tuple
t_{q}∈R₁ and in tuple tᵢ∈R₂.

Specifically, this probability is;

$${p}_{ij} = \frac{{υ}_{{t}_{q}} ( j ) \cdot {υ}_{{t}_{i}} ( j )}{{T}_{V} ( {t}_{q} )} .$$

(We describe below how we can compute;

T_{V}(t_{q}) efficiently without information about the individual entries σᵢ of Y(t_{q}).)

Let Cᵢ be the number of times that tᵢ appears in the sample of size S. It follows that:

Theorem 4.1 The expected value of

$$\frac{{C}_{i}}{S} \cdot Tv ( {t}_{q} )$$

is σᵢ.

The proof of this theorem follows from an argument similar to that of Section 4.1 and from the observation that the mean of the process that generates Cᵢ is

$$\frac{{\sum }_{j = 1}^{\vert D \vert} {υ}_{{t}_{q}} ( j ) {υ}_{{t}_{i}} ( j )}{{T}_{V} ( {t}_{q} )} = \frac{{σ}_{i}}{{T}_{V} ( {t}_{q} )} .$$

Theorem 4.1 establishes that, given a tuple t_{q}∈R₁, we can obtain a sample of size S of tuples tᵢ such that the frequency C; of tuple tᵢ can be used to approximate σᵢ. We can then report
[t_{q}, tᵢ]
as part of the answer R₁ [symbol] _{φ}R₂ for each tuple tᵢ∈R₂ such that its estimated similarity with t_{q} (i.e., its estimated σᵢ)is φ¹ or larger, where φ¹=(1−ε)φ is a slightly lower threshold, where ε is treated as a positive constant of less than 1, derived from Equations 1 and 2. An apparent problem of the sampling scheme proposed so far is the lack of knowledge of the value Tv(t_{q})².

We show that this value can be easily calculated without knowledge of the individual values σᵢ of V(t_{q}). First, we define Sum(j) as the total weight of the j-th token in relation;

$${R}_{2} , Sum ( j ) = {\sum }_{i = 1}^{\vert {R}_{2} \vert} {υ}_{{t}_{i}} ( j ) .$$

(These weights are kept in relation R₂Sum.) Then, it is the case that:

$$\begin{matrix}{T}_{V} ( {t}_{q} ) = {\sum }_{i = 1}^{\vert {R}_{2} \vert} {\sum }_{j = 1}^{\vert D \vert} {υ}_{{t}_{q}} ( j ) {υ}_{{t}_{i}} ( j ) \\ = {\sum }_{j = 1}^{\vert D \vert} {υ}_{{t}_{q}} ( j ) {\sum }_{i = 1}^{\vert {R}_{2} \vert} {υ}_{{t}_{i}} ( j ) \\ = {\sum }_{j = 1}^{\vert D \vert} {υ}_{{t}_{q}} ( j ) Sum ( j )\end{matrix} \qquad ( 3 )$$

Consequently, Tv(t_{q}) can be easily computed from the values stored in R2Sum and in R1Weights that are already computed using the SQL statements of the previous section.

Given R₁, R₂ and a threshold φ, our discussion suggests the following strategy for the evaluation of the R₁ [symbol] _{φ}R₂ text-join, in which we process one tuple t_{q}∈R₁ at a time:
Obtain an individual sample of size S from R₂ for t_{q}, using vector νₜ_{_{q}} to sample tuples of R₂ for each token with nonzero weight in νₜ_{_{q}}.
If Cᵢ is the number of times that tuple tᵢ appears in the sample for t_{q}, then use

$$\frac{{C}_{i}}{S} {T}_{V} ( {t}_{q} )$$

as an estimate of σᵢ.
Include tuple pair (t_{q}, tᵢ) in the text-join result only if

$$\frac{{C}_{i}}{S} {T}_{V} ( {t}_{q} ) > {ϕ}^{′}$$

$$( or equivalently {C}_{i} > \frac{S}{{T}_{V} ( {t}_{q} )} {ϕ}^{′} ) ,$$

), and filter out the remaining R₂ tuples. We refer to this filter as count filter.

This strategy guarantees that identify all pairs of tuples with similarity above φ, with a desired probability, as long as we choose an appropriate sample size S. So far, the discussion has focused on obtaining an R₂ sample of size S individually for each tuple;
t_{q}∈R₁.

A naive implementation of this sampling strategy would then require a scan of relation R₂ for each tuple in R₁, which is clearly unacceptable in terms of performance. In the next section we describe how we perform the sampling with only one sequential scan of relation R₂.

Practical Realization of Sampling

As discussed so far, our sampling strategy requires extracting a separate sample from R₂ for each tuple in R₁. This extraction of a potentially large set of independent samples from R₂ (i.e., one per R₁ tuple) is of course inefficient, since it would require a large number of scans of the R₂ table. In this section, we describe how we adapt the original sampling strategy so that it requires one single sample of R₂ and show how we use this sample to create an approximate answer for the text-join;
R₁ [symbol] _{φ}R₂,

As we have seen in the previous section, for each tuple;
t_{q}∈R₁
we should sample a tuple tᵢ from R₂ in a way that depends on the νₜ_{_{q}}(j)·νₜ_{ᵢ}(j) values. Since these values are different for each tuple of R₁, as straight forward implementation of this sampling strategy requires multiple samples of relation R₂. Here we describe an alternative sampling strategy that requires just one sample of R₂: First, we sample R₂using only the
νₜ_{_{q}}(j)
weights from the tuples tᵢ of R₂:, to generate a single sample of R₂:. Then, we use the single sample differently for each tuple t_{q} of R₁. Intuitively, we “weight” the tuples in the sample according to the weights
νₜ_{_{q}}(j) of the t_{q} tuples of R₁. In particular, for a desired sample size S and a target similarity φ, we realize our sampling-based text-join;
   R₁ [symbol] _{φ}R₂
   in three steps:.
1. Sampling: We sample the tuple ids i and the corresponding tokens from the vectors νₜ_{ᵢ} for each tuple tᵢεR₂. We sample each token j from a vector νₜ_{ᵢ}, with probability

$$\frac{{v}_{{t}_{i}} ( j )}{Sum ( j )} .$$

We perform S trials, yielding approximately S samples for each token j.
2. Weight: For each t_{q}εR₁ and for each token j with non-zero weight in νₜ_{_{q}}, scan the sample of R₂ and pick each tuple tᵢ with probability

$$\frac{{v}_{{t}_{q}} ( j ) \cdot Sum ( j )}{{T}_{V} ( {t}_{q} )} .$$

For each successful trial, add the corresponding tuple pair (t_{q}, tᵢ) to the candidate set.
3. Thresholding: After creating the candidate set, count the number of occurrences of each tuple pair (t_{q}, tᵢ). Add tuple pair (t_{q}, tᵢ) to the final result only if its frequency satisfies, the count filter (Section 4.2).

Such a sampling scheme identifies tuples with similarity above φ from R₂ for each tuple in R₁. Observe for each;
t_{q}∈R₁
we obtain S samples in total choosing samples according to;

$$\frac{{v}_{{t}_{q}} ( j ) {v}_{{t}_{i}} ( j )}{{T}_{V} ( {t}_{q} )}$$

in expectation.

By sampling R₂ only once, the sample will be correlated. As we verify experimentally in the Experimental Evaluation of the present invention, this sample correlation has negligible effect on the quality of the join approximation. The proposed solution, as presented, is asymmetric in the sense that it uses tuples from one relation(R₁) to weight samples obtained from the other (R₂). The text-join problem, as defined, is symmetric and does not distinguish or impose an ordering on the operands (relations). Hence, the execution of the text-join R₁ [symbol] _{φ}R₂ naturally faces the problem of choosing which relation to sample. We argue that we can choose either R₁ or R₂, as long as we also choose the appropriate sample size as described in the Similarity Sampling section. For a specific instance of the problem, we can break this asymmetry by executing the approximate join twice. Thus, we first sample from vectors of R₂ and use R₁ to weight the samples. Then, we sample from vectors of R₁ and use R₂ to weight the samples. Then, we take the union of these as our final result. We refer to this as a symmetric text-join. We will evaluate this technique experimentally in the Experimental Evaluation. In this section we have showed how to approximate the text-join R₁ [symbol] _{φ}R₂ by using weighted sampling. In the next section, we describe how this approximate join can be completely implemented using a standard, unmodified RDBMS.

Sampling and Joining Tuple Vectors in SQL

We now describe an SQL implementation of the sampling-based join algorithm of the previous section. There is first described the Sampling step, and then focuses on the Weight and Thresholding steps for the asymmetric versions of the join. Finally, the implementation of a symmetric version of the approximate join is described.

Implementing the Sampling Step in SQL

Given the RᵢWeights relations, we now show how to implement the Sampling step of our text-join approximation strategy in SQL. For a desired sample size S and similarity threshold φ, we create the auxiliary relation shown in FIG. 3. As the SQL statement in the figure shows, we join the relations RiWeights and RiSum on the token attribute. The P attribute for a tuple in the result is the probability;

$$\frac{Ri Weights . weight}{RiSum . total}$$

with which we should pick this tuple. Conceptually, for each tuple in the output of the query of FIG. 3 we need to perform S trials, picking each time the tuple with probability P. For each successful trial, we insert the corresponding tuple (tid, token) in a relation RiSample (tid, token), preserving duplicates. The SQL statement utilizes a relation R1V to implement the Weight step, storing the Tᵥ(t_{q}) values for each tuple t_{q}∈R₁. As described later, the R1V relation can be eliminated from the query and is just shown here for clarity. The S trials can be implemented in various ways. One (expensive) way to do this is as follows: We add “AND P≧RAND( )” in the WHERE clause of the FIG. 3 query, so that the execution of this query corresponds to one “trial.” Then, executing this query S times and taking the union of the all results provides the desired answer. A more efficient alternative, which is what we implemented, is to open a cursor on the result of the query in FIG. 3, read one tuple at a time, perform S trials on each tuple, and then write back the result. Finally, a pure-SQL “simulation” of the Sampling step deterministically defines that each tuple will result in;

$$Round ( S \cdot \frac{Ri Weights . weight}{RiSum . total} )$$

“successes” after S trials, on average. This deterministic version of the query is shown in FIG. 4. We have implemented and run experiments using the deterministic version, and obtained virtually the same performance as with the Cursor-based implementation of sampling over the FIG. 3 query. In the remainder of this description, in order to keep the discussion close to a probabilistic framework a cursor-based approach for the Sampling step is used.
Implementing the Weight and Thresholding Steps in SQL

The Weight and Thresholding steps are previously described as two separate steps. In practice, we can combine them into one SQL statement, shown in FIG. 5. The Weight step is implemented by the SUM aggregate in the “HAVING” clause”. We weight each tuple from the sample according to;

$$\frac{R1 Weights . weight \cdot R2 Sum . total}{R1 V . {T}_{V}} ,$$

Then, we can count the number of times that each which corresponds to;

$$\frac{{v}_{{t}_{q}} ( j ) \cdot Sum ( j )}{{T}_{V} ( {t}_{q} )}$$

The we can count the number of times that each particular tuple pair appears in the results (see GROUP BY clause). For each group, the result of the SUM is the number of times C; that a specific tuple pair appears in the candidate set. To implement the Thresholding step, we apply the count filter as a simple comparison in the HAVING clause: we check whether the frequency of a tuple pair exceeds the count threshold (i.e.;

$$( i . e . , {C}_{i} > \frac{S}{{T}_{V} ( {t}_{q} )} {ϕ}^{′} )$$

The final output of this SQL operation is a set of tuple id pairs with expected similarity exceeding threshold φ. The SQL statement in FIG. 5 can be further simplified by completely eliminating the join with the R1V relation. The RIV.Tv values are used only in the HAVING clause, to divide both parts of the inequality. The result of the inequality is not affected by this division, hence the R1V relation can be eliminated when combining the Weight and the Thresholding step into one SQL statement.

Implementing a Symmetric Text-Join Approximation in SQL

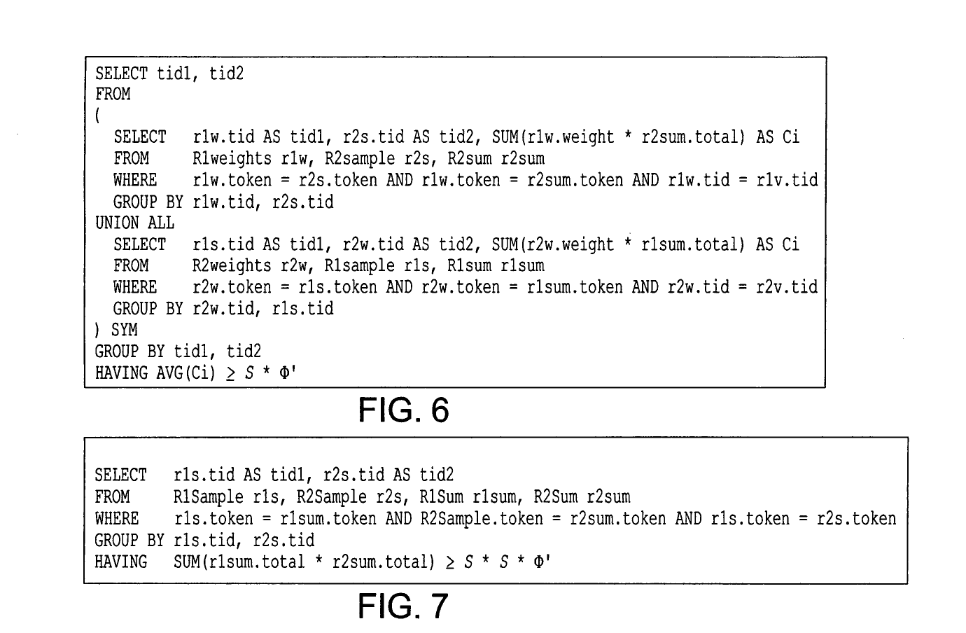

Up to now we have described only an asymmetric text-join approximation approach, in which we sample relation R₂ and weight the samples according to the tuples in R₁ (or vice versa). However, as we described previously, the text-join R₁ [symbol] _{φ}R₂ treats R₁ and R₂ symmetrically. To break the asymmetry of our sampling-based strategy, we execute the two different asymmetric approximations and report the union of their results, as shown in FIG. 6. Note that a tuple pair (tid1, tid2) that appears in the result of the two intervening asymmetric approximations needs high combined “support” to qualify in the final answer (see HAVING clause in FIG. 6).An additional strategy naturally suggests itself: Instead of executing the symmetric join algorithm by joining the samples with the original relations, we can just join the samples, ignoring the original relations. This version of the sampling-based text-join makes an independence assumption between the two relations. We sample each relation independently, join the samples, and then weight and threshold the output. We implement the Weight step by weighting each tuple with

$$\frac{R1 Sum . total}{R1 V . {T}_{V}} \cdot \frac{R2 Sum . total}{R2 V . {T}_{V}} .$$

The count threshold in this case becomes;

$${C}_{i} > \frac{S \cdot S}{{T}_{V} ( {t}_{q} ) \cdot {T}_{V} ( {t}_{i} )} {ϕ}^{′}$$

(again the Tᵥ values can be eliminated from the SQL if we combine the Weight and the Thresholding steps). FIG. 7 shows the SQL implementation of this version of the sampling-based text-join.
Experimental Evaluation

We implemented the proposed techniques and performed a thorough experimental evaluation in terms of both accuracy and performance. We first describe the techniques that we compare and the data sets and metrics that we use for our experiments. Then, we report the experimental results.

Experimental Settings

The schema and the relations described in Creating Weight Vectors for Tuples, were implemented on a commercial RDMBS, MicrosoftSQL Server 2000, running on a 550 MHz Pentium III-based PC with 768 Mb of RAM. SQL Server was configured to potentially utilize the entire RAM as a buffer pool.

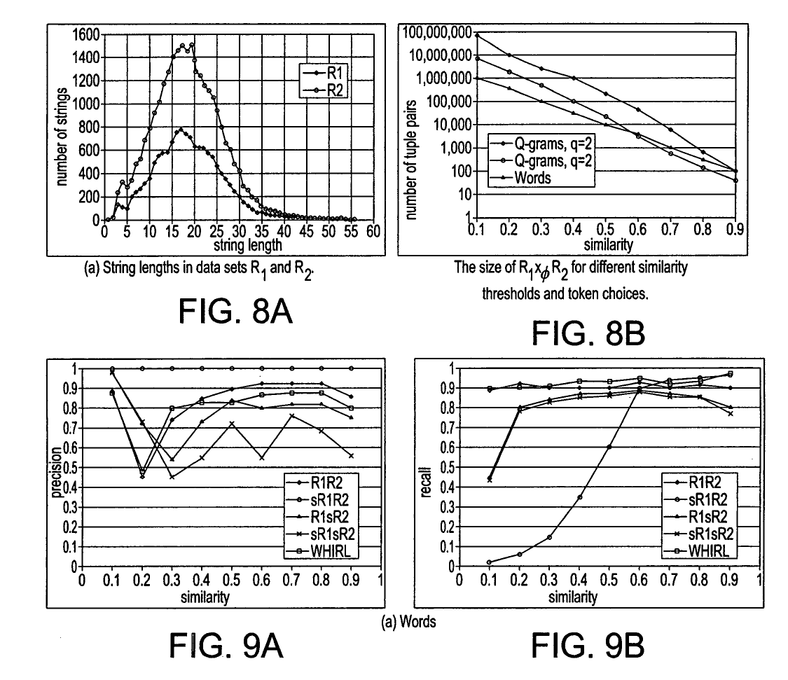

Data Sets: For our experiments, we used real data from an AT&T customer relationship database. We extracted from this database a random sample of 40,000 distinct attribute values of type string. We then split this sample into two data sets, R₁ and R₂. Data set R₁ contains about 14,000 strings, while data set R₂ contains about 26,000 strings. The average string length for R₁ is 19 characters and, on average, each string consists of 2.5 words. The average string length for R₂ is 21 characters and, on average, each string consists of 2.5 words. The length of the strings follows a close-to-Gaussian distribution for both data sets and is reported in FIG. 8(a), while the size of;

R₁ [symbol] _{φ}R₂ for different similarity thresholds φ and token choices is reported in FIG. 8(b). Metrics: To evaluate the accuracy and completeness of our techniques we use the standard precision and recall metrics:

Definition 3 Consider two relations R₁ and R₂ and a user-specified similarity threshold φ. Let Answer_{φ} be an approximate answer for test-join R₁ [symbol] _{φ}R₂. Then, the precision and recall of Answer_{φ}with respect to R₁ [symbol] _{φ}R₂ are defined as:

$$precision = \frac{\vert {Answer}_{ϕ} ⋂ ( {R}_{1} {ϕ}_{} {R}_{2} ) \vert}{\vert {Answer}_{ϕ} \vert} and recall = \frac{\vert {Answer}_{ϕ} ⋂ ( {R}_{1} {ϕ}_{} {R}_{2} ) \vert}{\vert {R}_{1} {ϕ}_{} {R}_{2} \vert}$$

Precision and recall can take values in the 0-to-1 range. Precision measures the accuracy of the answer and indicates the fraction of tuples in the approximation of;
R₁ [symbol] _{φ}R₂
that are correct. In contrast, recall measures the completeness of the answer and indicates the fraction of the;
R₁ [symbol] _{φ}R₂
tuples that are captured in the approximation. For data cleaning applications, we believe that recall is more important than precision. The returned answer can always be checked for false positives in a post-join step, while we cannot locate false negatives without re-running the text-join algorithm. Finally, to measure the efficiency of the algorithms, we measure the actual execution time of the similarity join for different techniques.
Techniques Compared:

We compare the following algorithms for computing (an approximation of);
R₁ [symbol] _{φ}R₂

All of these algorithms can be deployed completely within an RDBMS:
Baseline: This expensive algorithm (FIG. 2) computes the exact answer for R₁ [symbol] _{φ}R₂ by considering all pairs of tuples from both relations.
R1δR2: This asymmetric approximation of R₁ [symbol] _{φ}R₂ samples relation R₂ and weights the sample using R₁ (FIG. 5).
sR1R2: This asymmetric approximation of R₁ [symbol] _{φ}R₂ samples relation R₁ and weights the sample using R₂.
R1R2: This symmetric approximation of R₁ [symbol] _{φ}R₂ is shown in FIG. 6.
sR1sR2: This symmetric approximation or R₁ [symbol] _{φ}R₂ joins the two samples R1Sample and R2Sample (FIG. 7).

In addition, we also compare the SQL-based techniques against the stand-alone WHIRL system.

Given a similarity threshold φ and two relations R₁ and R₂, WHIRL computes the text-join
R₁ [symbol] _{φ}R₂

The fundamental difference with our techniques is that WHIRL is a separate application, not connected to any RDBMS. Initially, we attempted WHIRL over our data sets using its default settings. Unfortunately, during the computation of the
R₁ [symbol] _{φ}R₂
join WHIRL ran out of memory. We then limited the maximum heap size 6 to produce an approximate answer for
R₁ [symbol] _{φ}R₂

We measure the precision and recall of the WHIRL answers, in addition to the running time to produce them. Choice of Tokens: We present experiments for different choices of tokens for the similarity computation. The token types that we consider in our experiments are:
Words: All space-delimited words in a tuple are used as tokens (e.g., “AT&T” and “Labs” for string “AT&T Labs”).
Q-grams: All substrings of q consecutive characters in a tuple are used as tokens (e.g., “$A,” “AT&T&,” “&T,” “T ,” “L,” “La,” “ab,” “bs,” “s#,” for string “AT&T Labs” and q=2, after we append dummy characters “$” and “#” at the beginning and end of the tuple). We consider q=2 and q=3.

The RiWeights table has 30,933 rows for Words, 268_{—}458 rows for Q-grams with q=3, and 245,739 rows for Q-grams with q=2. For the R2Weights table, the corresponding numbers of rows are 61,715, 536,982,and 491_{—}515. In FIG. 8(b) we show the number of tuple pairs in the exact result of the text-join;
R₁ [symbol] _{φ}R₂
for the different token choices and for different similarity thresholds;
φ

Unfortunately, WHIRL natively supports only word tokenization but not q-grams. To test WHIRL with q-grams, we adopted the following strategy: We generated all the q-grams of the strings in R₁ and R₂, and stored them as separate “words.” For example, the string “ABC” was transformed into “$A ABBC C#” for q=2. Then WHIRL used the transformed data set as if each q-gram were a separate word. Besides the specific choice of tokens, three other main parameters affect the performance and accuracy of our techniques: the sample size S, the choice of the user-defined similarity threshold φ₁, and the choice of the error margin ε.. We now experimentally study how these parameters affect the accuracy and efficiency of sampling-based text-joins.

Experimental Results

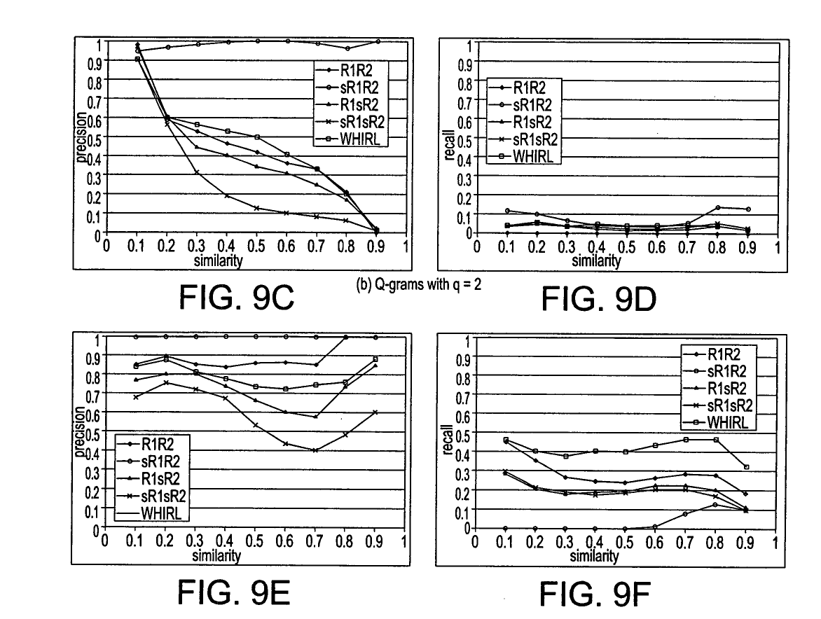

Comparing Different Techniques: Our first experiment evaluates the precision and recall achieved by the different versions of the sampling-based text-joins and for WHIRL (FIG. 9). For sampling-based joins, a sample size of S=128 is used (we present experiments for varying sample size S below). FIG. 9(a) presents the results for Words and FIGS. 9(b)(c) present the results for Q-grams, for q=2 and q=3. WHIRL has perfect precision (WHIRL computes the actual similarity of the tuple pairs),but it demonstrates very low recall for Q-grams. The low recall is, to some extent, a result of the small heap size that we had to use to allow WHIRL to handle our data sets. The sampling-based joins, on the other hand, perform better. For Words, they achieve recall higher than 0.8 for thresholds φ>0.1, with precision above 0.7 for most cases when φ>0.2 (with the exception of the sR1sR2 technique). WHIRL has comparable performance for φ>0.5. For Q-grams with q=3, sR1R2 has recall around 0.4 across different similarity metrics, with precision consistently above 0.7, outperforming WHIRL in terms of recall across all similarity thresholds. When q=2, none of the algorithms performs well. For the sampling-based text-joins this is due to the small number of different tokens for q=2. By comparing the different versions of the sampling-based joins we can see that sR1sR2 Performs worse than the other techniques in terms of precision and recall. Also, R1sR2 is always worse than sR1R2: Since R₂ is larger than R₁ and the sample size is constant, the sample of R₁ represents the R₁ contents better than the corresponding sample of R₂ does for R₂

Effect of Sample Size S:

The second set of experiments evaluates the effect of the sample size

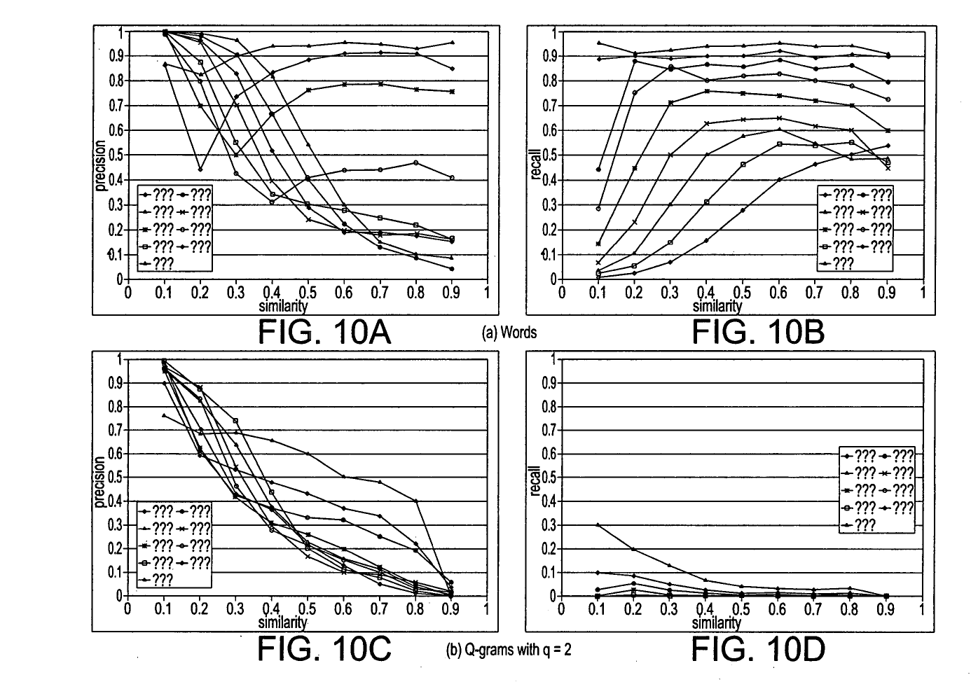

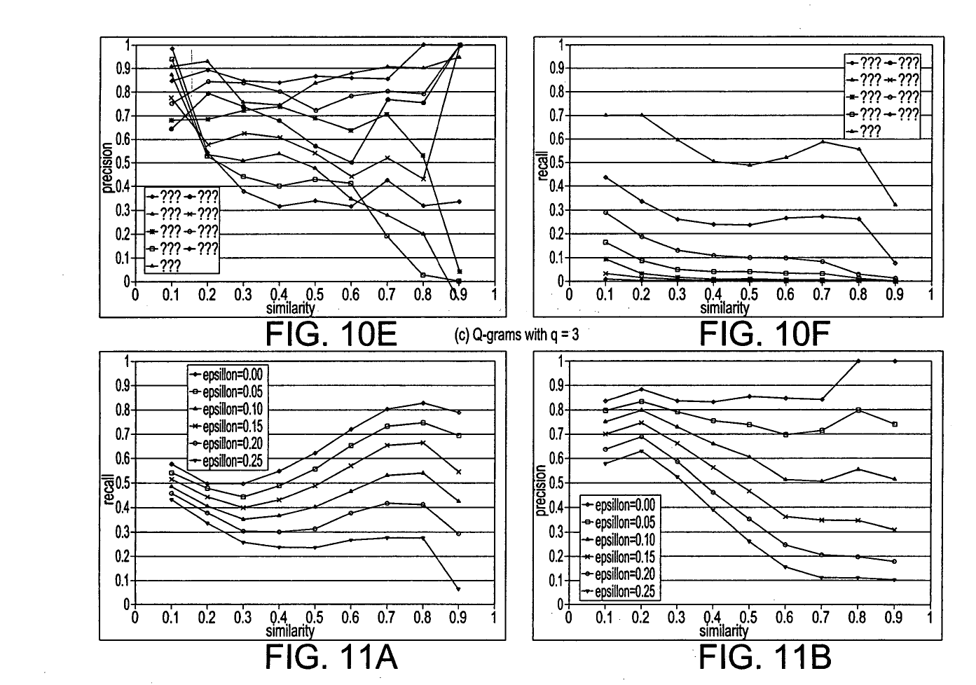

As we increase the number of samples S for each distinct token of the relation, more tuples are sampled and included in the final sample. This results in more matches in the final join, and, hence in higher recall. It is also interesting to observe the effect of the sample size for different token choices. The recall for Q-grams with q=2 is smaller than that for Q-grams with q=3 for a given sample size, which in turn is smaller than the recall for Words. Since we independently obtain a constant number of samples per distinct token, the higher the number of distinct tokens the more accurate the sampling is expected to be. This effect is visible in the recall plots of FIG. 10. The sample size also affects precision. When we increase the sample size, precision generally increases. However, in specific cases we can observe that smaller sizes can in fact achieve higher precision. This happens because for a smaller sample size we may get an underestimate of the similarity value (e.g., estimated similarity 0.5 for real similarity 0.7).Underestimates do not have a negative effect on precision. However, an increase in the sample size might result in an overestimate of the similarity, even if the absolute estimation error is smaller (e.g., estimated similarity 0.8 for real similarity 0.7). Overestimates, though, affect precision negatively when the similarity threshold φ happens to be between the real and the (over)estimated similarity.

Effect of Error Margin ε:

As mentioned in previously, the threshold for count filter is;

$$\frac{S}{Tv ( {t}_{q} )} ( 1 - ε ) ϕ .$$

Different values of ε affect the precision and recall of the answer. FIG. 11 shows how different choices of ε affect precision and recall. When we increase ε, we lower the threshold for count filter and more tuple pairs are included in the answer. This, of course, increases recall, at the expense of precision: the tuple pairs included in the result have estimated similarity lower than the desired threshold φ. The choice of ε is an “editorial” decision, and should be set to either favor recall or precision. As discussed above, we believe that higher recall is more important for data cleaning applications. The returned answer can always be checked for false positives in a post-join step, while we cannot locate false negatives without re-running the text-join algorithm.

Execution Time:

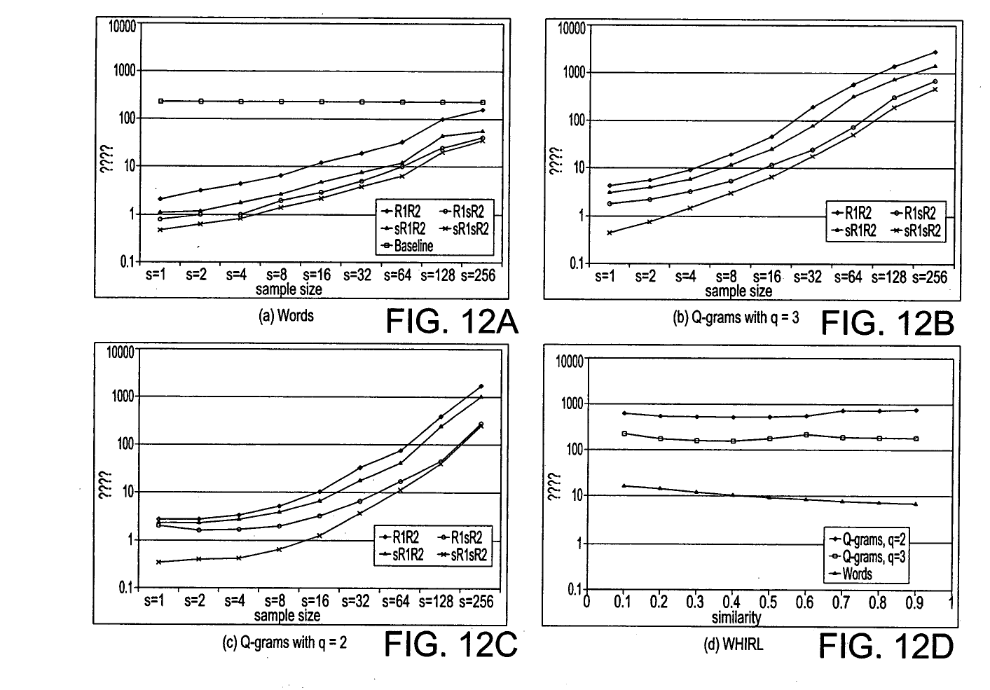

To analyze efficiency, we measure the execution time of the different techniques. Our measurements do not include the preprocessing step to build the auxiliary tables in FIG. 1: This preprocessing step is common to the baseline and all sampling-based text-join approaches. This preprocessing step took less than two minutes to process both relations R₁ and R₂ for Words, and about five minutes for Q-grams. Also, the time needed to create the RiSample relations is less than five seconds. For WHIRL we similarly do not include the time needed to export the relations from the RDBMS to a text file formatted as expected by WHIRL, the time needed to load the text files from disk, or the time needed to construct the inverted indexes 7. The preprocessing time for WHIRL is about 15 seconds for Words and one minute for Q-grams, which is smaller than for the sampling-based techniques: WHIRL keeps the data in main memory, while we keep the weights in materialized relations inside the RDBMS. The Baseline technique (FIG. 2) could only be run for Words. For Q-grams, SQL Server executed the Baseline query for approximately 7 hours before finishing abnormally. Hence, we only report results for Words for the Baseline technique. FIG. 12(a) reports the execution time of sampling-based text-join variations for Words, for different sample sizes. The execution time of the join did not change considerably for different similarity thresholds, and is consistently lower than that for Baseline. The results for FIG. 12 were computed for similarity threshold, φ=0.5; the execution times for other values of φ are not significantly different. For example, for S=64, a sample size that results in high precision and recall (FIG. 10(a)), R1R2 is more than 10 times faster than Baseline. The speedup is even higher for sR1R2 and R1sR2. FIGS. 12(b) and 12(c) report the execution time for Q-grams with q=2 and q=3. Not surprisingly, sR1sR2, which joins only the two samples, is considerably faster than the other variations.

TABLE 1
Different similarity functions for data cleansing, and
the types of string mismatches that they can capture.

| Similarity | Mismatches | Mismatches not |
|---|---|---|
| Function | Captured | Captured |
| Edit distance | Spelling errors, insertions | Variation, of word order, |
| | and deletions of short words | insertions and deletions of |
| | | long words |
| Block edit | Spelling errors, insertions | Insertions and deletions of |
| distance | and deletions of short words, | long words |
| | variations of word order | |
| Cosine simi- | Insertions and deletions of | Spelling errors |
| larity with | common words, variations | |
| words as | of word order | |
| tokens | | |
| Cosine simi- | Spelling errors, insertions | — |
| larity with | and deletions of short or | |
| q-gram as | common words, variations of | |
| tokens | word order | |

This faster execution, however, is at the expense of accuracy (FIG. 9). For all choices of tokens, the symmetric version R1R2 has an associated execution time that is longer than the sum of the execution times of sR1R2 and R1sR2. This is expected, since R1R2 requires executing, sR1R2 and R1sR2 to compute its answer. Finally, FIG. 12(d) lists the execution time for WHIRL, for different similarity thresholds. For Q-grams with q=3, the execution time for WHIRL is roughly comparable to that of R1sR2 when S=128. For this setting R1sR2 has recall generally at or above 0.2, while WHIRL has recall usually lower than 0.1. For Words, WHIRL is more efficient than the sampling-based techniques for high values of S, while WHIRL has significantly lower recall for low to moderate similarity thresholds (FIG. 9(a)). For example, for S=128 sampling-based text-joins have recall above 0.8 when;
φ>0.1
and WHIRL has recall above 0.8 only when;
φ>0.5.

In general, the sampling-based text-joins, which are executed in an unmodified RDBMS, have efficiency comparable to WHIRL, provided that WHIRL has sufficient main memory available: WHIRL is a stand-alone application that implements a main-memory version of the A* algorithm. This algorithm requires keeping large search structures during processing; when main memory is not sufficiently large for a dataset, WHIRL's recall suffers considerably. In contrast, our techniques are fully executed within RDBMSs, which are specifically designed to handle large data volumes in an efficient and scalable way.

Using Different Similarity Functions for Data Cleansing

The Experimental Evaluation studied the accuracy and efficiency of the proposed sampling-based text-join executions according to the present invention, for different token choices and for a distance metric based on tf.idf token weights. We now compare this distance metric against string edit distance, especially in terms of the effectiveness of the distance metrics in helping data cleansing applications. The edit distance between two strings is the minimum number of edit operations (i.e., insertions, deletions, and substitutions) of single characters needed to transform the first string into the second. The edit distance metric works very well for capturing typographical errors. For example, the strings “ComputerScience” and “Computer Science” have edit distance one. Also edit distance can capture insertions of short words (e.g., “Microsoft” and “Microsoft Co” have edit distance three). Unfortunately, a small increase of the distance threshold can result in many false positives, especially for short strings. For example, the string “IBM” is within edit distance three of both “ACM” and “IBM Co. ”The simple edit distance metric does not work well when the compared strings involve block moves (e.g., “Computer Science Department” and “Department of Computer Science”). In this case, we can use block edit distance, a more general edit distance metric that allows for block moves as a basic edit operation. By allowing for block moves, the block edit distance can also capture word rearrangements. Finding the exact block edit distance of two strings is an NP-hard problem. Block edit distance cannot capture all mismatches. Differences between records also occur due to insertions and deletions of common words. For example, “KAR Corporation International” and “KAR Corporation” have block edit distance 14. If we allow large edit distance threshold capture such mismatches, the answer will contain a large number of false positive matches. The insertion and deletion of common words can be handled effectively with the cosine similarity metric that we have described in this paper if we use words as tokens. Common words, like “International,” have low idf weight. Hence, two strings are deemed similar when they share many identical words (i.e., with no spelling mistakes) that do not appear frequently in the relation. This metric also handles block moves naturally. The use of words as tokens in conjunction with the cosine similarity as distance metric was proposed by WHIRL. Unfortunately, this similarity metric does not capture word spelling errors, especially if they are pervasive and affect many of the words in the strings. For example, the strings “Computer Science Department” and “Department of Computer Science” will have zero similarity under this metric. Hence, we can see that (block) edit distance and cosine similarity with words serve complementary purposes for data cleansing applications. Edit distance handles spelling errors well (and possibly blockmoves as well), while the cosine similarity with words nicely handles block moves and insertions of words. A similarity function that naturally combines the good properties of the two distance metrics is the cosine similarity with q-grams as tokens. A block move minimally affects the set of common q-grams of two strings, so the two strings “Gateway Communications” and “Communications Gateway” have high similarity under this metric. A related argument holds when there are spelling mistakes in these words. Hence, “Gateway Communications” and “Communications Gateway” will also have high similarity under this metric despite the block move and the spelling errors in both words. Finally this metric handles the insertion and deletion of words nicely. The string “Gateway Communications” matches with high similarity the string “Communications Gateway International” since the q-grams of the word “International” appear often in the relation and have low weight. Table 1 summarizes the qualitative properties of the distance functions that we have described in this section. The choice of similarity function impacts the execution time of the associated text-joins. The use of the cosine similarity with words leads to fast query executions as we have seen in the Experimental Evaluation. When we use q-grams, the execution time of the join increases considerably, resulting nevertheless in higher quality of results with matches that neither edit distance nor cosine similarity with words could have captured. Given the improved recall and precision of the sampling-based text join when q=3 (compared to the case where q=2), we believe that the cosine similarity metric with 3-grams can serve well for data cleansing applications.

It will be appreciated that the present invention has been described herein with reference to certain preferred or exemplary embodiments. The preferred or exemplary embodiments described herein may be modified, changed, added to or deviated from without departing from the intent, spirit and scope of the present invention. It is intended that all such additions, modifications, amendments, and/or deviations be included within the scope of the claims appended hereto.

1) A system for string matching across multiple relations in a relational database management system comprising:
generating a set of strings from a set of characters,
decomposing each string into a subset of tokens,
establishing at least two relations within said strings,
establishing a similarity threshold for said relations,
sampling said at least two relations,
correlating said relations for said similarity threshold and
returning all of said tokens which meet the criteria of said similarity threshold.
